(19) United States
(12) Patent Application Publication
(10) Pub. No.: US 2015/0234127 A1
(43) Pub. Date: Aug. 20, 2015

(54) ELECTRICAL AND OPTICAL HYBRID CONNECTOR

(71) Applicant: HON HAI PRECISION INDUSTRY CO., LTD., New Taipei (TW)

(72) Inventors: GANG PAUL CHEN, Walnut, CA (US); JUN-BIN HUANG, Eastvale, CA (US); KEITH ALLEN BOURNE, Chester, VA (US); JIM ZHAO, Irvine, CA (US); YUAN-CHIEH LIN, Lake Forest, CA (US); AN-JEN YANG, Irvine, CA (US)

(73) Assignee: HON HAI PRECISION INDUSTRY CO., LTD., New Taipei (TW)

(21) Appl. No.: 14/184,577

(22) Filed: Feb. 19, 2014

(51) Int. Cl. G02B 6/38

(52) U.S. Cl. CPC G02B 6/3817; G02B 6/3853

(57) ABSTRACT

A mezzanine connector assembly adapted to connecting a top PCB and a bottom PCB. The mezzanine connector assembly includes a floatable upper connector and a lower connector. The upper connector has an electrical connecting device and an optical connecting device. The electrical connecting device includes a conductor having a floatable upper end and a fixed lower end, the optical connecting device having an optical waveguide with one end connected to the upper PCB and a lower end fixed to the housing by a ferrule. The lower connector has a housing, a turning lens received in the housing, and an electrical contact connected to the bottom PCB for mating with the lower end of the conductor of the upper connector, the turning lens defining an upward opening to receive the ferrule of the upper connector, a forward opening for receiving an optical plug.

### BACKGROUND OF THE INVENTION

1. Field of the Invention

The present invention relates to an electrical and optical hybrid connector, and especially relates to a connector providing electrical and optical hybrid connections from a module board to a parallel main board.

2. Description of Related Art

U.S. Pat. No. 6,684,007, issued to Yoshimura et al. on Jan. 27, 2004, discloses an electrical and optical hybrid connection between a substrate and a backplane. Electrical traces on the top surface of a substrate are to be routed to the edge of the substrate and mechanically coupled to a conventional electrical connector in a first receptacle mounted on the backplane. An active layer (optical waveguide) from the substrate is aligned to a vertical coupler in another layer of the backplane. A second receptacle is adhered to the top surface of the backplane. When a multichip module (substrate) is inserted into the first receptacle, flexibility of the active layer enables it to be guided into the second receptacle. In such arrangement, the substrate is perpendicular to the backplane.

In view of the foregoing, the present invention is to provide an electrical and optical hybrid connector connecting parallel module board and main board.

### SUMMARY OF THE INVENTION

Accordingly, an object of the present invention is to provide a mezzanine connector assembly adapted to connecting a top PCB and a bottom PCB. The mezzanine connector comprises an upper connector mounted to a bottom side of the top PCB and a lower connector mounted onto a top side of the bottom PCB. The upper connector has an electrical connecting device and an optical connecting device. The electrical connecting device comprises a conductor having an upper end connected to the upper PCB and a lower end opposite to the upper end. The optical connecting device has a flexible optical waveguide with an upper end connected to the upper PCB and a lower end, and a ferrule fixing the lower end. The lower connector has a housing, a turning lens received in the housing, and an electrical contact connected to the bottom PCB for mating with the lower end of the conductor of the upper connector. The turning lens defines an upward opening to receive the ferrule of the upper connector, and a forward opening for insertion of an optical plug couple connected to the bottom PCB.

Accordingly, a second object of the present invention is to provide a connector assembly adapted to be mounted onto a module board. The connector assembly comprises a housing, an electrical connecting device and an optical connecting device. The housing is mounted to the module board in a way permitting the housing to float horizontally along the module board. The housing forms a tower having a foot end adapted to be mounted onto the module board and an opposite tip end. The tower comprises a front portion and a rear portion. The electrical connecting device has a conductor received in the rear portion. The conductor has a first contact fixed to the tip end of the tower therefore floatable together with the housing, a second contact adapted to connect the module board and a flexible wire connected between the first contact and the second contact. The optical connecting device has a flexible optical waveguide and a ferrule fixing a first end of the optical waveguide to the tip end of the tower therefore floatable together with the housing. The optical waveguide has an opposite second end opposite to the first end and adapted to connect the module board.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a hybrid connector assembly connecting two parallel boards according to a preferred embodiment of the instant invention.

FIG. 2 is a perspective view of the electrical connector assembly shown in FIG. 1, a top PCB removed.

FIG. 3 is an exploded view of an upper connector and the top PCB shown in FIG. 1.

FIG. 4 is another exploded view of an upper connector and the top PCB shown in FIG. 1.

FIG. 5 is a perspective view of the upper connector shown in FIG. 1.

FIG. 6 is another perspective view of the upper connector shown in FIG. 1.

FIG. 7 is partial exploded view of the upper connector shown in FIG. 1.

FIG. 8 is a bottom view of the upper connector and the top PCB shown in FIG. 1.

FIG. 9 is a cross-section of the upper connector taken along a line of IX-IX shown in FIG. 8.

FIG. 10 is a perspective view of the lower connector shown in FIG. 1, with the bottom PCB and an optical plug in assembled position.

FIG. 11 is a perspective view of the lower connector, the bottom PCB and the optical plug in exploded position.

FIG. 12 is a top view of the lower connector, the bottom PCB and the optical plug shown in FIG. 10.

FIG. 13 is a cross-section of the lower connector, the bottom PCB and the optical plug taken along the line of XIII-XIII shown in FIG. 10.

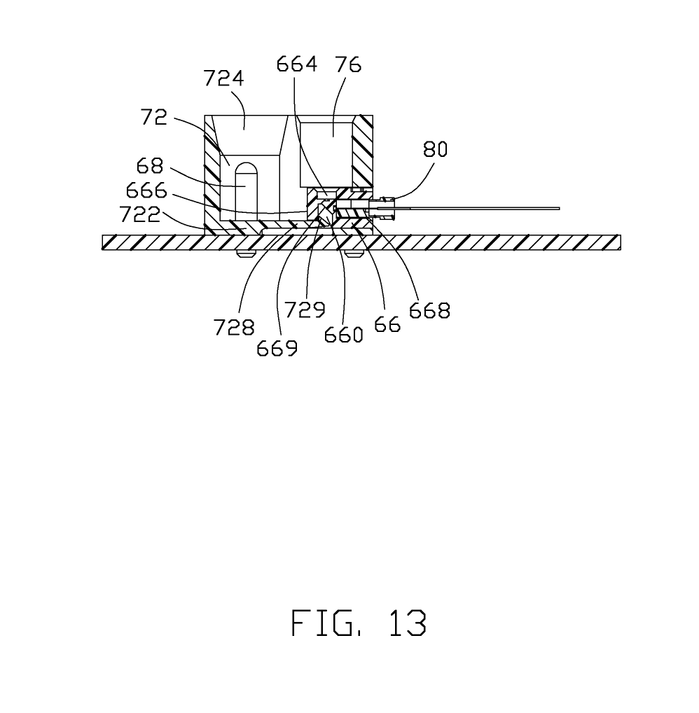

FIG. 14 is a cross-section of the lower connector, the bottom PCB and the optical plug taken along the line of XIV-XIV shown in FIG. 10.

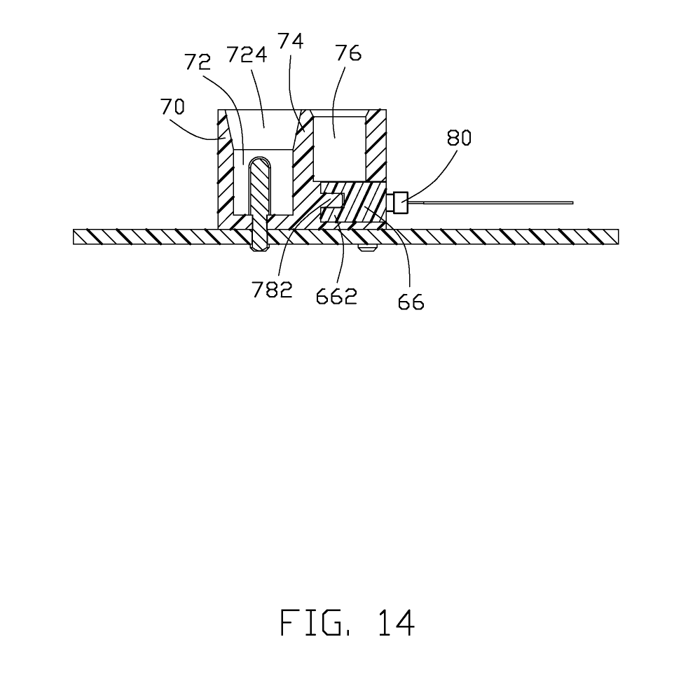

### DETAILED DESCRIPTION OF THE PREFERRED EMBODIMENT

Reference will now be made in detail to the preferred embodiment of the present invention.

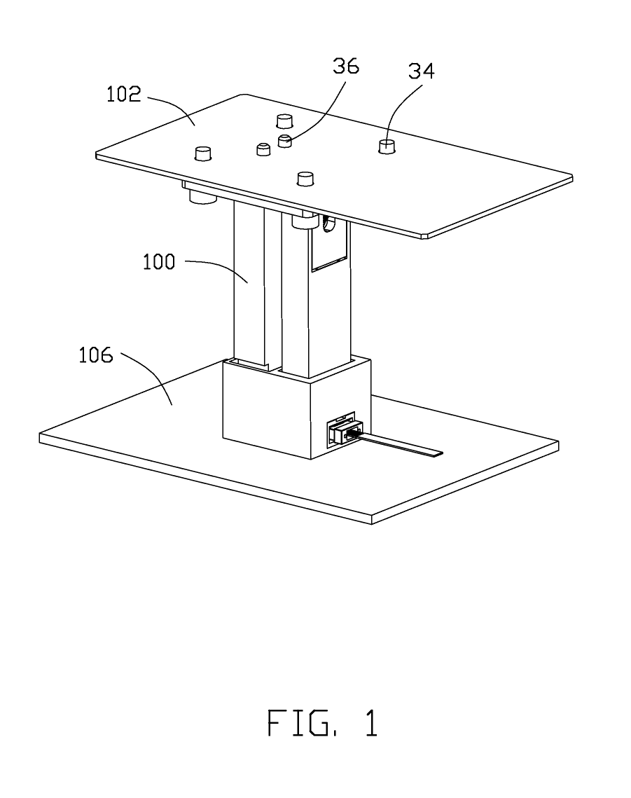

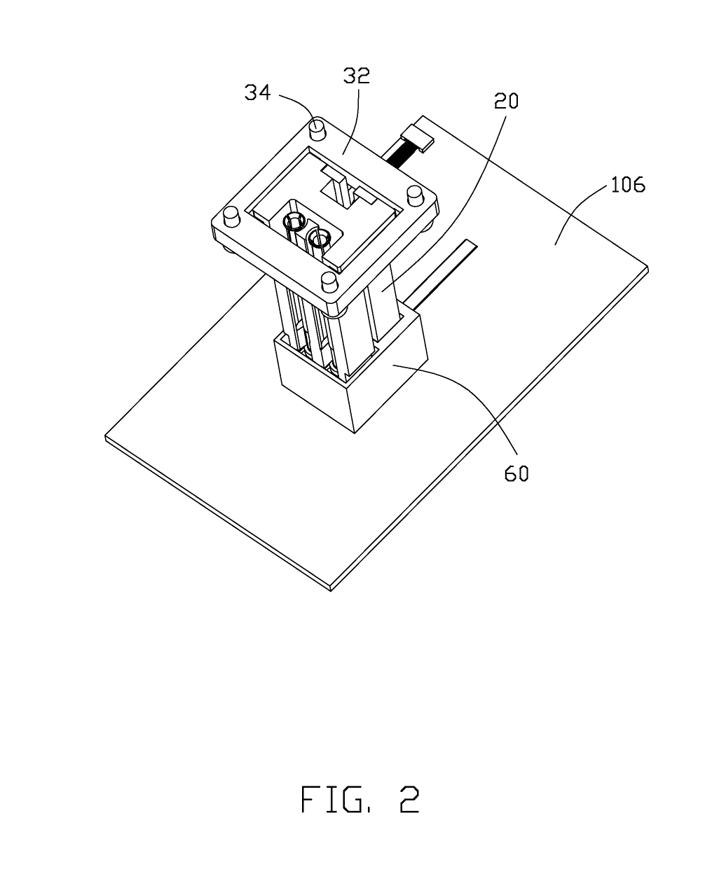

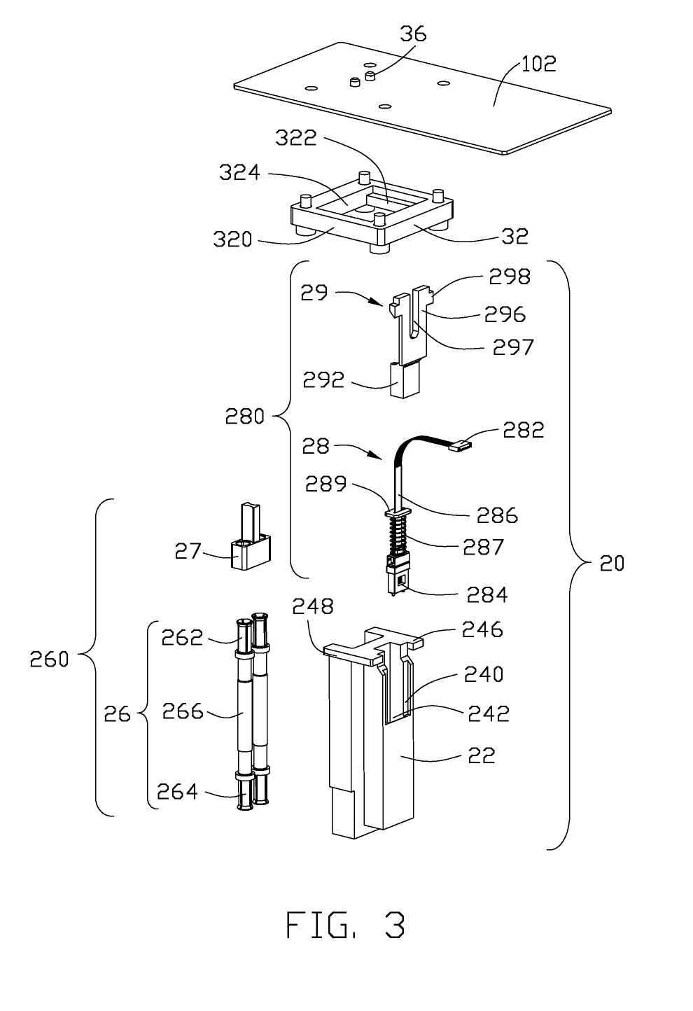

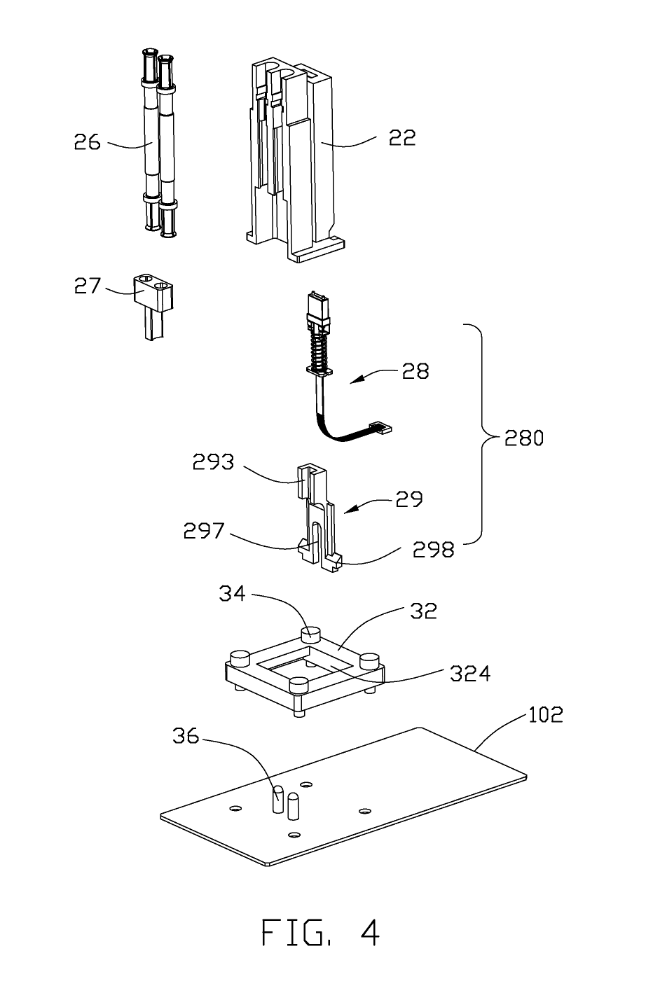

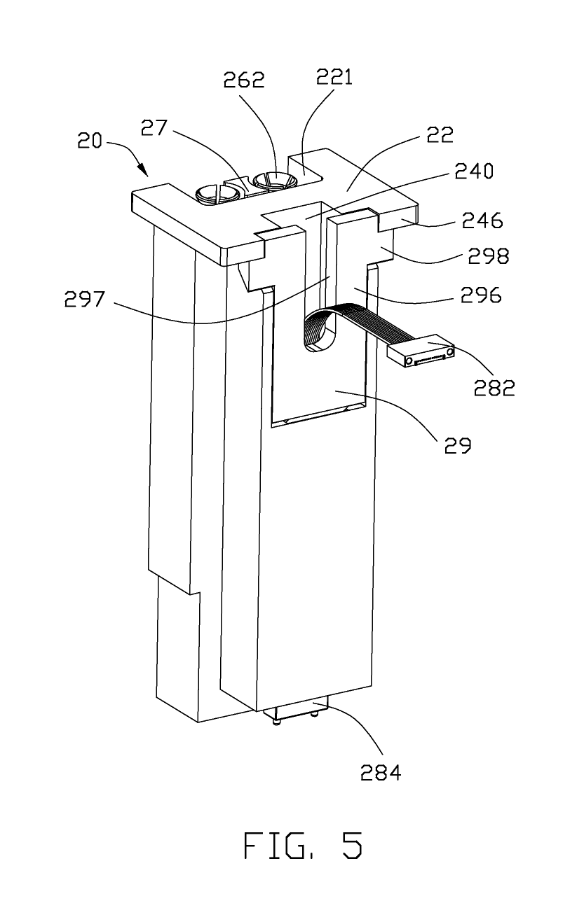

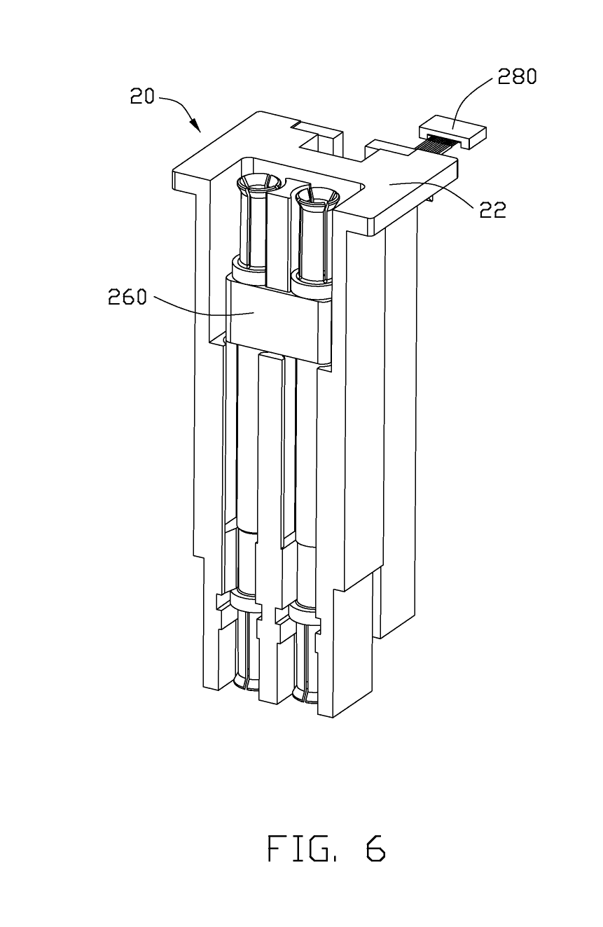

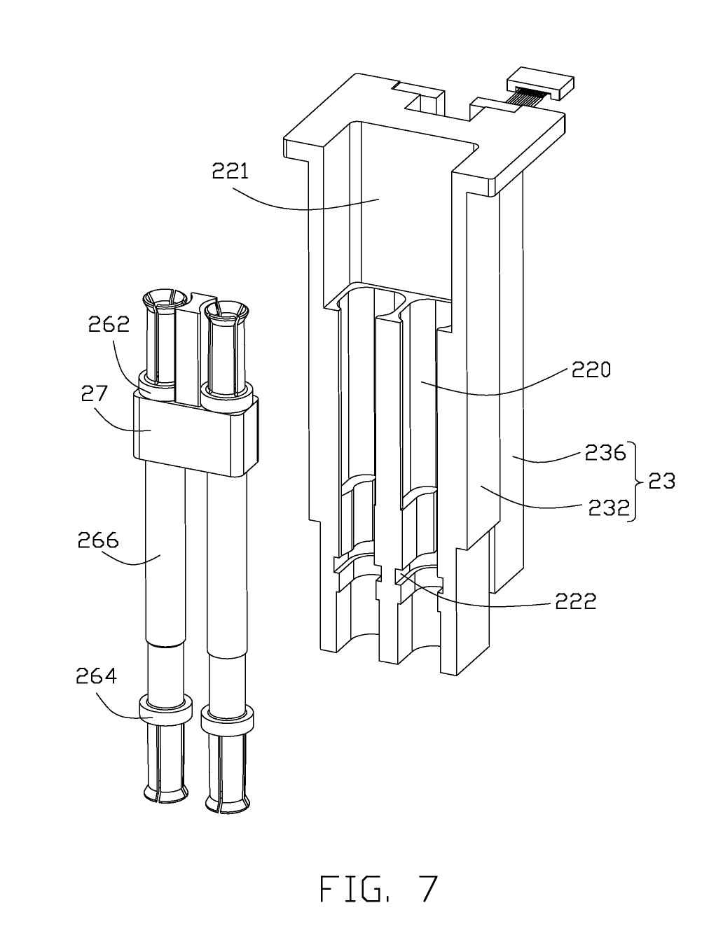

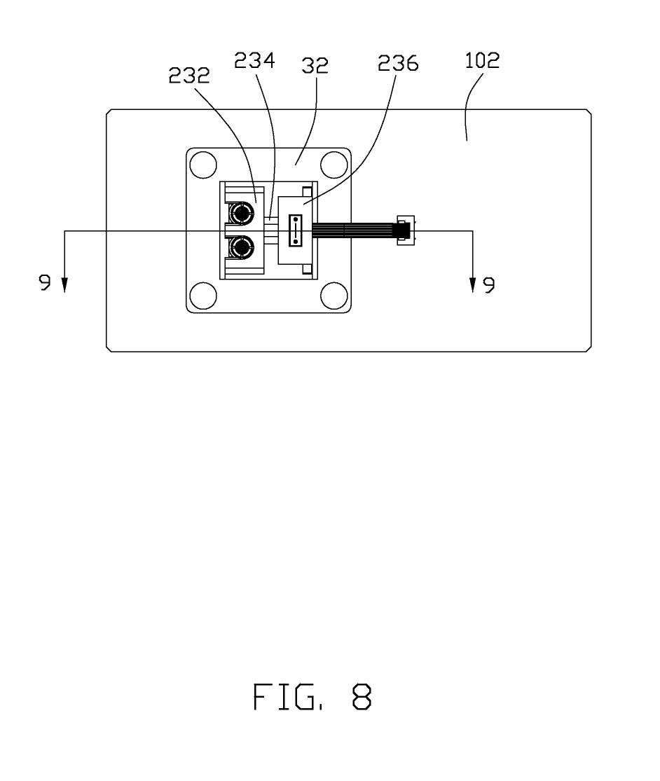

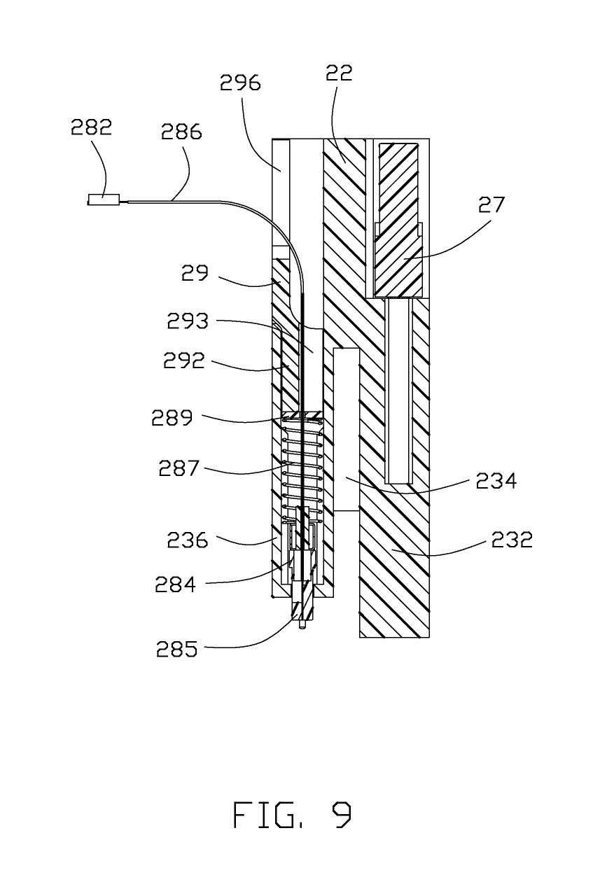

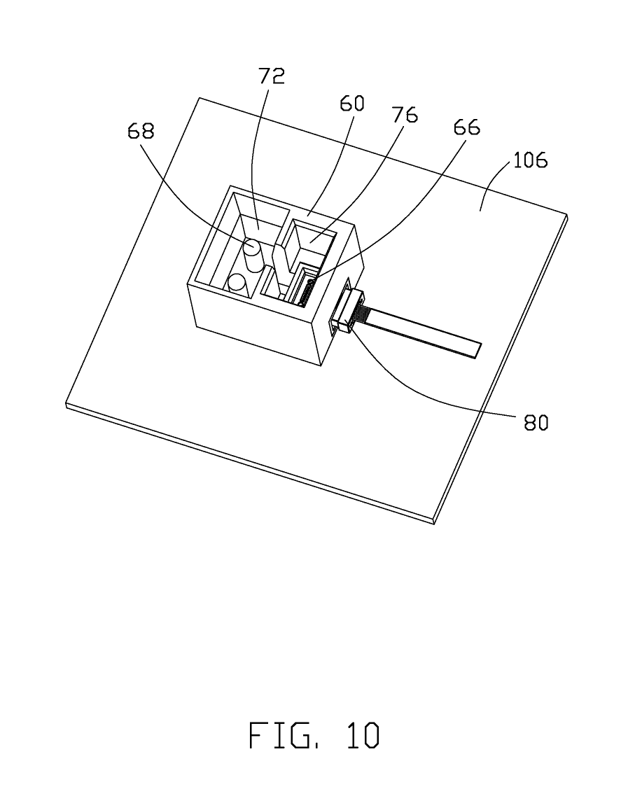

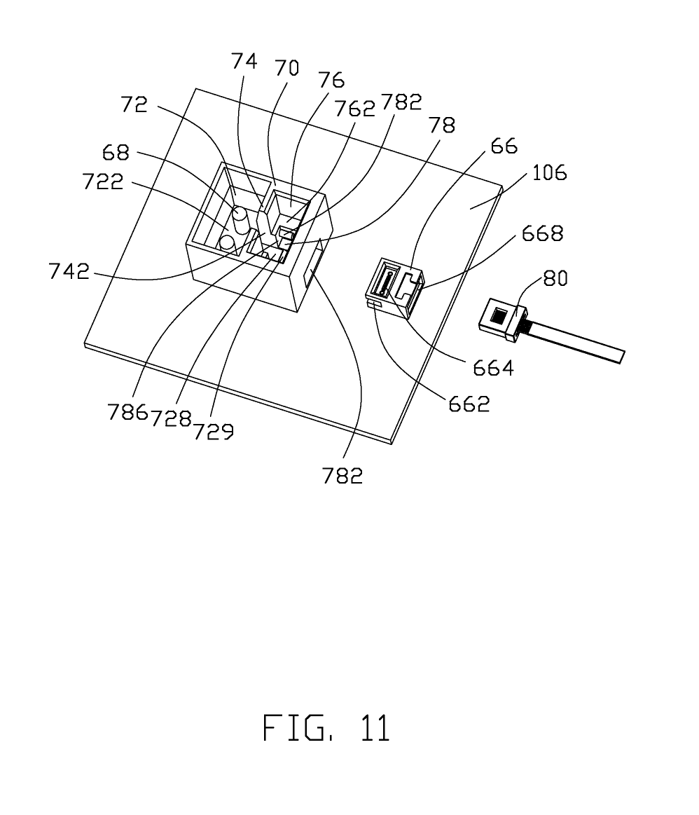

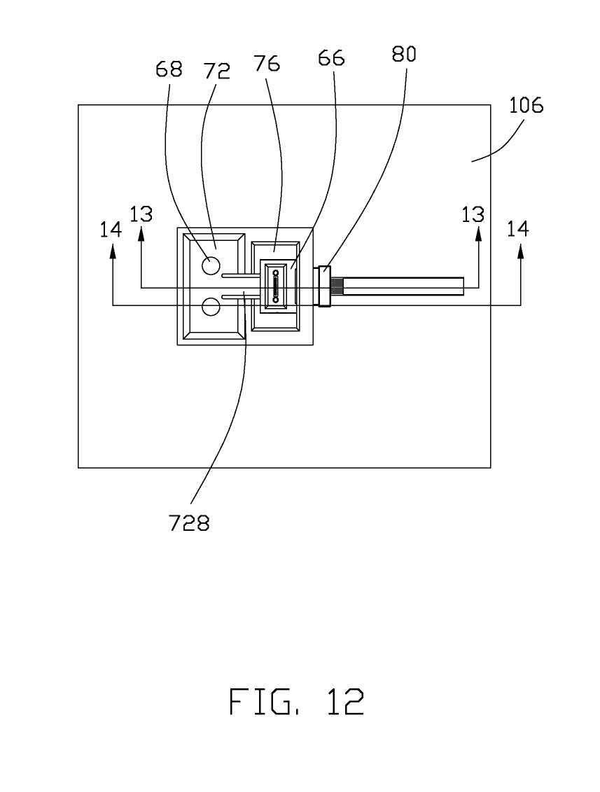

Referring FIGS. 1-12, a connector assembly 100 combined with electrical and optical connection is shown. The connector assembly 100 is intended to provide two electrical connections and one of more fiber optic connections between a fixed bottom PCB (bottom PCB) 106 and a module board (top PCB) 102. The connector assembly 100 includes an upper connector 20 mounted onto a lower side of the top PCB 102 and a lower connector 60 mounted onto an upper side of the bottom PCB 106.

The lower connector 60 includes an lower insulating housing 220, two conductive pins 68 and a turning lens 66. The lower insulating housing 70 is rigidly fixed to the bottom PCB 106 via two plastic posts 702 that insert into two holes 107 on the bottom PCB 106 and two copper pins 68 that are soldered to the bottom PCB 106.

The lower insulating housing 70 defines a rear cavity 72 and a front cavity 76 both opening upwardly. The lower insulating housing 70 includes a middle wall 74 separating the rear cavity 72 and the front cavity 76, a rear bottom wall 722 in the rear cavity 72 fixing the two conductive pins 68, and a front bottom wall 762 in the front cavity 76 stepping upwardly related to the rear bottom wall 722. The front bottom wall 762 defines a lower cavity 78 having an upward entrance 786 communicating the front cavity 76 and a forward entrance 782 communicating outside of the lower insulating housing 70. The rear bottom wall 722 forms a flexible latch arm 728 forwardly extending into the lower cavity 78 along a bottom side of the lower cavity 78. The latch arm 728 has a latch block 729 bulging upwardly into the lower cavity 78. The insulating housing 72 defines a vertical slot 742 upwardly exposing an upper side of the latch arm 728 to facilitate the molding of the latch arm 728.

The turning lens 66 is inserted into the lower cavity 78 through the forward entrance 782. The turning lens 66 defines a forward opening 668 for receiving an optical plug 80, an upward opening 664 for the optic connection of the upper connector 20 and a downward opening 660. A 45-degree mirror 669 is defined in the downward opening 660 for transferring lights between the optical plug 80 and the optic connections of the upper connector 20. The turning lens 66 further define a pair of guide slot 662 in transversely side faces for mating with a pair of guide ribs 782 formed in the lower cavity 78 of the lower insulating housing 70. The turning lens 66 forms a rear wall 666 behind the downward opening 660. When the turning lens 66 is fully inserted into the lower cavity 78, the latching bock 729 snaps into the downward opening 660 and mating with a front face of the rear wall 666, thereby holding the turning lens 66 inside the lower connector 60. The turning lens 66 can mate to two MT ferrules positioned at 90 degrees relative to each other. The latch arm 728 can be made to release the turning lens 66 for removal by pressing on the latch with a small screwdriver through the vertical slot 742.

The upper connector 20 includes an upper insulating housing 22. The upper insulating housing 22 forms a tower 23 extending downwardly and two mounting flanges 248 oppositely extending from upper end of the tower 23 in a transverse direction. The tower 23 has a foot end adapted to be mounted onto the top PCB 102 and a tip end extending pointing towards the bottom PCB 106. The connector retention plate 32 forms a rectangular frame 320. The rectangular frame 320 defines a center opening 324 with the tower 23 downwardly penetrating therethrough. The rectangular frame 320 further defines two horizontal step faces 322 upwardly abutting the two mounting flange 248. There is enough clearance between the rectangular frame 32 and the tower 23 so that the upper insulating housing 22 can floating in all lateral direction while keeping the mounting flanges 248 abutted upward by the rectangular frame 320. Therefore, the upper connector 20 is allowed to laterally float in order to accommodate misalignment between the bottom PCB 106 and module board 102. The max movement of the upper connector 20 in the lateral directions is about 1.0 millimeter. The retention plate 32 is equipped with a spring device (not shown) that help center the floating upper connector 20 prior to mating. The retention plate 32 is secured to the module board 102 via four M3 screws 34 and nuts (not shown).

The upper insulating housing has a rear branch 232 and a front branch 236 connected by two ribs 234. The upper connector 20 further includes an electrical connecting device 260 and an optical connecting device 280. The rear branch 232 of the upper insulating housing 22 defines two rearward opening slots 220 vertically extending therethrough and an upper cavity 221 to receive the electrical connecting device 260. The front branch 236 of the upper insulating housing 22 defines a front vertical channel 240 receiving the optical connecting device 280.

The electrical connecting device 260 includes two conductors 26 and a receptacle holder part 27. Each of the two conductors 26 includes an upper copper receptacle (upper contact) 262, a lower copper receptacle (lower contact) 264, and a multi-stranded wire (flexible wire) 266 connected therebetween. The two upper copper receptacles 262 are fastened by the receptacle holder part 27 and maintained a set distance and electrically isolated from each other. The upper copper receptacles 262 and the receptacle holder part 27 are received in the upper cavity 221 and allowed to float along lateral direction related to the upper insulating housing 22. The lower copper receptacles 264 are rigidly fixed to the upper insulating housing 22. Each of copper receptacle 262, 264 cramps corresponding ends of the multi-stranded wire 266. The top PCB 102 is equipped with two conductive pins 36 respectively mate into the upper copper receptacles 262, thereby connected to the upper copper receptacles 262. The lower copper receptacles 264 respectively mate with the conductive pins 68 soldered to the bottom PCB 106, thereby connected to the bottom PCB 106. Each of the rearward opening slots 220 defines a guiding groove 222 rearward extending through the upper insulating housing 22 for fixing corresponding one of the two lower copper receptacles 264.

The optical connecting device 280 includes a MT ferrule 284 vertically slidably received in the channel 240, a fiber pigtail (flexible optical waveguide) 286 downwardly extending into the MT ferrule 284, a wire compression spring 287 positioned around the fiber pigtail 286 within the channel 240, a steel spring plate 289 above the wire compression spring 287, and a plastic spring block 29. The upper insulating housing 22 defines a front opening 242 communicating the vertical channel 240 to a front side of the upper insulating housing 22. The plastic spring block 29 has a head 292 received in the vertical channel 240, a pair of spring branches 296 upwardly extending and a pair of positioning ears 298. The head 292 defines a pigtail receiving slot 293 opening rearward. The pair of spring branches 296 are received in the front opening 242 and disposed transversely to define a center slot 297. The fiber pigtail 286 extends forwardly through the center slot 297 to couple with the top PCB 102. The wire compression spring 287 pushes against the MT ferrule 284 and the steel spring plate 289. The steel spring plate 289 is in turn retained by the head 292 of the plastic spring block 29. The upper insulating housing 22 forms a pair of positioning blocks 246 making a snapping engagement with corresponding positioning ears 296 of the plastic spring block 29. The pair of positioning blocks 246 are used to prohibit the plastic spring block 29 from further upward moving. The ferrule 284 is positioned in the vertical channel 240 with a lower end 285 downwardly extending beyond the front branch 236.

During mating of the top PCB 102 and the bottom PCB 106, under a lead-in structure of the lower connector 60, the upper connector 20 laterally moves as required to insure that the upper connector 20 and the lower connector 60 properly align. The rear cavity 72 has a longer bell-shaped mouth 724. The rear branch 232 of the upper insulating housing 22 downwardly extends beyond the front branch 236 so that the rear branch 232 make an engagement with the rear cavity 72 prior to an engagement of the front branch 236 and the front cavity 76. The lower receptacles 264 mate with the conductive pins 68 soldered into the bottom PCB 106. Then, the lower end 285 of the spring-loaded MT ferrule 284 mates into the upward opening 664 of the turning lens 66 and the fiber pigtail 286 is aligned with the 45-degree mirror 669. The forward opening 668 is adapted to receive an optical plug 80 aligned with the 45-degree mirror 669 so that signal light could be transferred between the fiber pigtail 286 and the optical plug 80. The optical pigtail 286 has an upper end terminated with another optical plug 282 for mating with an optical receptacle (not shown) mounted on the top PCB 102, thereby connected to the top PCB 102.

It is to be understood, however, that even though numerous characteristics and advantages of the present invention have been set fourth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mezzanine connector assembly adapted for connecting a top PCB and a bottom PCB, comprising:
an upper connector mounted to a bottom side of the top PCB, the upper connector having an electrical connecting device and an optical connecting device, the electrical connecting device comprising a conductor having an upper end connected to the upper PCB and a lower end opposite to the upper end, the optical connecting device having an optical waveguide with an upper end connected to the upper PCB and a lower end, and a ferrule fixing the lower end; and
a lower connector mounted onto a top side of the bottom PCB, the lower connector having a housing, a turning lens received in the housing, and an electrical contact connected to the bottom PCB for mating with the lower end of the conductor of the upper connector, the turning lens defining an upward opening to receive the ferrule of the upper connector and a forward opening for receiving an optical plug.

2. The mezzanine connector assembly as claimed in claim 1, wherein the housing of the lower connector defines a lower cavity receiving the turning lens in a replaceable way.

3. The mezzanine connector assembly as claimed in claim 2, wherein the lower cavity having a forward entrance communicating outside of the housing permitting insertion of the turning lens into the lower cavity, the housing having a latch arm engaging with the turning lens in a releasable way.

4. The mezzanine connector assembly as claimed in claim 3, wherein the upper connector comprising a housing forming a tower extending downwardly, the tower having a front portion receiving the optical connecting device and a rear portion receiving the electrical connecting device, the housing of the lower connector defining a front cavity above the lower cavity and a rear cavity, the front cavity communicating the lower cavity and receiving a lower end of the front portion of the housing of the upper connector, the rear cavity receiving a lower end of the rear portion of the housing of the upper connector.

5. The mezzanine connector assembly as claimed in claim 4, wherein the rear cavity has a bottom wall, the latch arm extending from the bottom wall of the rear cavity to a bottom side of the lower cavity and forming a latch block bulging upwardly therefrom.

6. The mezzanine connector assembly as claimed in claim 3, wherein the turning lens defines a downward opening and a rear wall behind the downward opening, the latch block engaging with a front face of the rear wall.

7. The mezzanine connector assembly as claimed in claim 6, wherein the turning lens forms a 45-degree mirror in the downward opening for coupling the optical plug to the ferrule of the upper connector.

8. The mezzanine connector assembly as claimed in claim 4, wherein the rear cavity of the housing of the lower connector has a longer bell-shaped mouth, the lower end of the rear portion of the housing of the upper connector downwardly extending beyond the front portion so that the rear portion make a primary guiding engagement with the rear cavity prior to an engagement of the front portion and the front cavity.

9. The mezzanine connector assembly as claimed in claim 5, wherein the insulating housing defines a vertical slot upwardly exposing an upper side of the latch arm to facilitate the molding of the latch arm.

10. A connector assembly adapted to be mounted onto a module board, comprising:
a housing mounted to the module board in a way permitting the housing to float horizontally along the module board, the housing forming a tower having a foot end adapted to be mounted onto the module board and an opposite tip end, the tower comprising a front portion and a rear portion,
an electrical connecting device having a conductor received in the rear portion, the conductor having a first contact fixed to the tip end of the tower so as to be floatable together with the housing, a second contact adapted to connect the module board, and a flexible wire connected between the first contact and the second contact; and
an optical connecting device having a flexible optical waveguide and a ferrule fixing a first end of the optical waveguide to the tip end of the tower so as to be floatable together with the housing, the optical waveguide having a second end opposite to the first end and adapted to connect the module board.

11. The connector assembly as claimed in claim 10, wherein the insulating housing forms a flange at the foot end of the tower, the connector assembly further comprising a retention plate rigidly fixed to the module board, the retention plate forming a rectangular frame, the rectangular frame defining a center opening with the tower of the housing penetrating therethrough and a horizontal step face with the flange resting thereon, enough clearance provided between the rectangular frame and the tower so that the upper insulating housing can floating in all lateral directions while the flange slides on the horizontal step face.

12. The connector assembly as claimed in claim 10, wherein the second end of the flexible optical waveguide forwardly extends from the housing, the second end terminated to another ferrule free from the housing.

13. The connector assembly as claimed in claim 12, wherein the housing defines a vertical channel in the front portion, said ferrule received in the vertical channel and pushed by a compression spring towards the tip end of the tower, the compression spring compressed by a spring block and the spring block in turn compressed by a positioning block formed by the housing.

14. The connector assembly as claimed in claim 13, wherein the housing defines a front opening at the foot end communicating the vertical channel to a front side of the upper insulating housing, the spring block having a head inside the vertical channel, a pair of spring branches received in the front opening and a center slot between the pair of the spring branches, the flexible optical waveguide getting through the center slot.

15. The connector assembly as claimed in claim 10, wherein the electrical connecting device has a plurality of said conductors and a contact holder part floatable together with the housing, the contact holder part fastening the second contacts of each of said conductors.

16. The connector assembly as claimed in claim 10, wherein the housing defines a cavity at the foot end of the tower and a plurality of vertical slots vertically extending from the cavity to the tip end of the tower, the conductors and the contact holding part forwardly mounted into the cavity and the vertical slots.

17. A board-to-board assembly comprising:
opposite first and second printed circuit boards spaced from each other in a parallel relation;
an insulative housing assembly positioned between the opposite first and second printed circuit boards, said insulative housing assembly defining an electrical transmission half and an optical transmission half independent and spaced from each other; wherein
the electrical transmission half includes a pair of conductors with solid parts at two opposite ends to respectively connect the opposite first and second printed circuit boards and a flexible cable therebetween for comply with the variable distance between the opposite first and second printed circuit board, and the optical transmission half defines an optical connector urged to one of said opposite first and second printed circuit boards via a spring.

18. The board-to-board assembly as claimed in claim 17, wherein the insulative housing assembly includes two opposite units respectively assembled to the corresponding first and second printed circuit boards, and a middle elongated unit restrainedly between said opposite units.

19. The board-to-board assembly as claimed in claim 17, further including a spring block detachably assembled to the insulative housing assembly to constantly urging the optical connector to said one of the opposite first and second printed circuit boards.

20. The board-to-board assembly as claimed in claim 19, wherein the spring block defines a slot to allow an optical fiber assembly to extend therethrough for couple to an external part.
